(19) United States
(12) Patent Application Publication
(10) Pub. No.: US 2026/0168224 A1
(43) Pub. Date: Jun. 18, 2026

(54) FLUSH VALVE ASSEMBLY

(71) Applicant: ADPma, LLC, Piney Flats, TN (US)

(72) Inventor: DAVID BLYTHE, CHURCH HILL, TN (US)

(21) Appl. No.: 19/388,562

(22) Filed: Nov. 13, 2025

Related U.S. Application Data
(60) Provisional application No. 63/720,090, filed on Nov. 13, 2024.

(51) Int. Cl. E03D 3/04; B64D 11/02

(52) U.S. Cl. CPC E03D 3/04; B64D 11/02

(57) ABSTRACT

An airplane flush valve assembly with an improved face seal assembly and slide plate design to resist leakage. The flow of wastewater through the fluid channel is controlled by rotational movement of the slide plate with a through-hole. The through-hole in the slide plate is moved from a closed position into an open position in the fluid channel when the flush valve is activated, and subsequently rotates back to the closed position after the flushing process is complete. A face seal assembly with a quad-seal is used to prevent the flow of air and other contaminants around the slide plate The quad-seal of the present invention forms a four-lobed X-shape in cross section, and has multiple points of contact with the slide plate and the housing groove.

This application claims benefit of and priority to U.S. Prov. App. No. 63/720,090, filed Nov. 13, 2024, which is incorporated herein in its entirety by specific reference for all purposes.

### FIELD OF INVENTION

This invention relates to a flush valve assembly with enhanced sealing for use on aircraft.

### BACKGROUND OF INVENTION

Flush valves and flush valve assemblies for aircraft are known in the prior art. However, prior art flush valves frequently develop leaks due to constant aircraft lavatory system vacuum/suction, which results in air constantly being pulled past the flush valve face seal, through the tubes, and into the waste tank. This causes any debris that may be in the tubes to dry out, progressively reducing the interior passage size within the tubes and eventually resulting in clogged tubes. In addition, components in prior art flush valve motor assemblies are not sealed units, and thus are susceptible to water ingress and internal contamination and corrosion.

### SUMMARY OF INVENTION

In various exemplary embodiments, the present invention comprises a flush valve assembly with an improved face seal assembly and slide plate design to resist leakage. In addition, the flush valve motor assembly described herein for use with the flush valve assembly provides improved mechanical properties and enhanced leak and corrosion resistance.

The present invention controls the flow of wastewater through the fluid channel by rotational movement of the slide plate. The through-hole in the slide plate is moved from a closed position into an open position in the fluid channel when the flush valve is activated, and subsequently rotates back to the closed position after the flushing process is complete. A face seal assembly is used to prevent the flow of air and other contaminants around the slide plate The present invention addresses the problem of leakage in aircraft lavatory systems, which are subject to a harsh environment with constant suction (either from a vacuum generator or air pressure differential), with a quad-seal (which may also be referred to as a quad-ring, X-ring, or X-seal). The quad-seal of the present invention forms a four-lobed X-shape in cross section. The quad-seal of the present invention has two points of contact with the slide plate, two points of contact with the side wall of the housing groove, and two points of contact with the inner wall of the housing groove. In several embodiments, the quad-seal is a solid piece of rubber, preferably nitril butadiene rubber.

Further, the slide plate of the present invention utilizes a full radius in the through-hole (i.e., smooth, without chamfers or other sharp edges in the through-hole) to reduce the occurrence of damage to the mating seals during actuation of the flush valve.

### BRIEF DESCRIPTION OF THE FIGURES

FIG. 1 shows a partial cross-sectional view of a flush valve seal assembly in accordance with an exemplary embodiment of the present invention.

FIG. 2 shows an example of a slide plate for use in the seal assembly of FIG. 1.

FIG. 3 shows a perspective view of the exterior of the flush valve motor assembly for use with the flush valve assembly in accordance with an exemplary embodiment of the present invention.

FIG. 4 shows an exploded view of the internal components of the flush valve motor assembly of FIG. 3.

FIG. 5 shows a side view and front view of the flush valve motor assembly of FIG. 3.

FIG. 6 shows a diagram of an overtemperature protection and EMI filtering circuit for use with the flush valve motor assembly of FIG. 3.

### DETAILED DESCRIPTION OF EXEMPLARY EMBODIMENTS

In various exemplary embodiments, the present invention comprises a flush valve assembly with an improved face seal assembly and slide plate design to resist leakage. In addition, the flush valve motor assembly described herein for use with the flush valve assembly provides improved mechanical properties and enhanced leak and corrosion resistance.

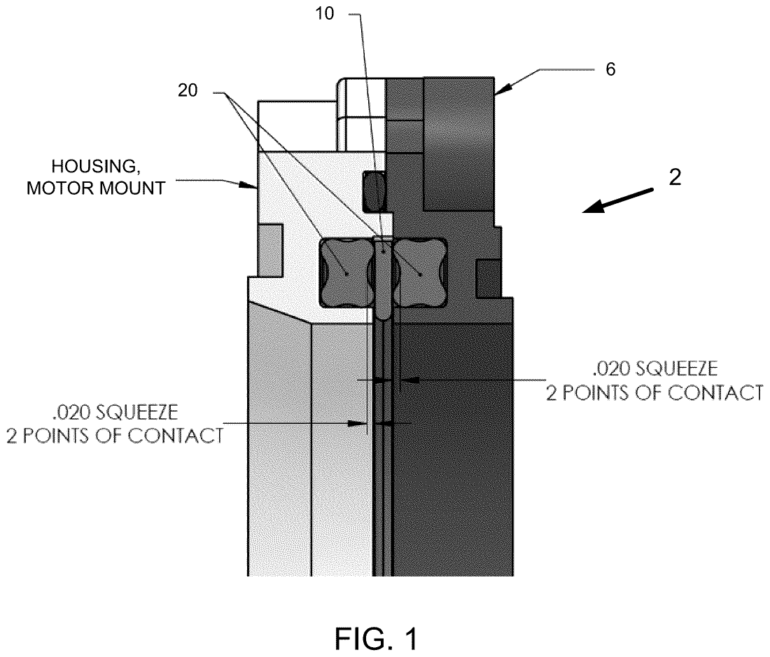

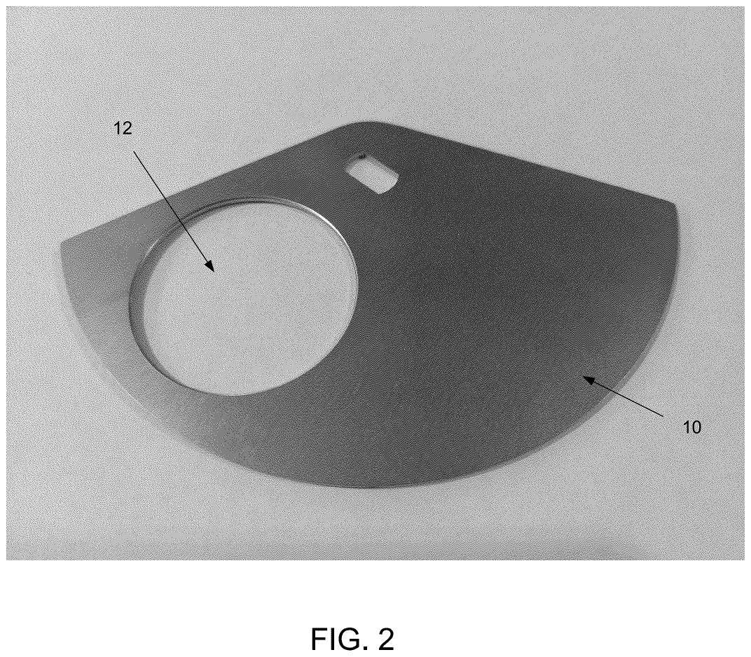

FIG. 1 shows an exemplary embodiment of the improved flush valve assembly 2 of the present invention. The flow of wastewater through a fluid channel is controlled by rotational movement of the slide plate 10 (an example of which is shown in FIG. 2) within the assembly housing 8. The through-hole 12 in the slide plate 10 is moved from a closed position into an open position in the fluid channel when the flush valve is activated, and subsequently rotates back to the closed position after the flushing process is complete.

A face seal assembly is used to prevent the flow of air and other contaminants from or into the fluid channel around the slide plate 10. Prior art face seal assemblies typically comprise an outer housing made from polyethylene and a hollow inner ring made from silicone rubber (e.g., siloxane copolymer) which acts as an energizer to keep positive pressure between the seal and the slide plate to create the seal. However, prior art seal assemblies have a single point of contact with the slide plate and a single point of contact with the inner wall of the housing groove. As aircraft lavatory systems are subject to a harsh environment with constant suction (either from a vacuum generator or air pressure differential), the prior art seal assembly often begins to leak, allowing air to be constantly pulled past the face seal, through the wastewater tubes and into the wastewater tank. This causes waste and other debris that may be in the tubes to dry out, progressively reducing passage size and eventually clogging of the tubes. Fluid leakage also leads to corrosion and premature wear of the flush valve assembly and motor assembly.

The present invention addresses this problem with a quad-seal 20 (which may also be referred to as a quad-ring, X-ring, or X-seal). As seen in FIG. 1, the quad-seal of the present invention forms a four-lobed X-shape in cross section. Unlike the prior art outer housing and inner ring, the quad-seal 20 of the present invention has two points of contact with the slide plate, two points of contact with the side wall of the housing groove, and two points of contact with the inner wall of the housing groove. In several embodiments, the quad-seal is a solid piece of rubber, preferably nitril butadiene rubber.

The housing of prior art seal assemblies comprises a high strength engineering plastic (polyetherimide) comprising 30% glass. The 30% glass, however, allows for some moisture absorption and also creates internal stresses in the material. These prior art housings often will change shape slightly to neutralize those internal stresses, which can contribute to prior art seals not working properly. The housing of the present invention comprises polyetheretherketone polymer, which is high strength without glass filler, and with very low water absorption, which reduces or eliminates any change in the shape of the housing over time.

Further, the inner edge of the through-hole of prior art slide plates are manufactured with sharp chamfers, which can damage the mating seals. The slide plate 10 of the present invention utilizes a full radius in the through-hole (i.e., smooth, without chamfers or other sharp edges) to reduce the occurrence of damage to the mating seals during actuation of the flush valve.

There are other improvements made to the slide plate 10 of the present invention. It is constructed of 400 C stainless steel (heat treated to 52-59 HRC) to reduce wear, as opposed to the 310 stainless steel (approx. 41 HRC) used in prior art assemblies. The slide plate of the present invention also is electropolished to a 4 micro-finish (as compared to a 12.1 finish for prior art slide plates) to delay the onset of corrosion and contamination by eliminating surface imperfections and contaminants embedded in the plate's surface.

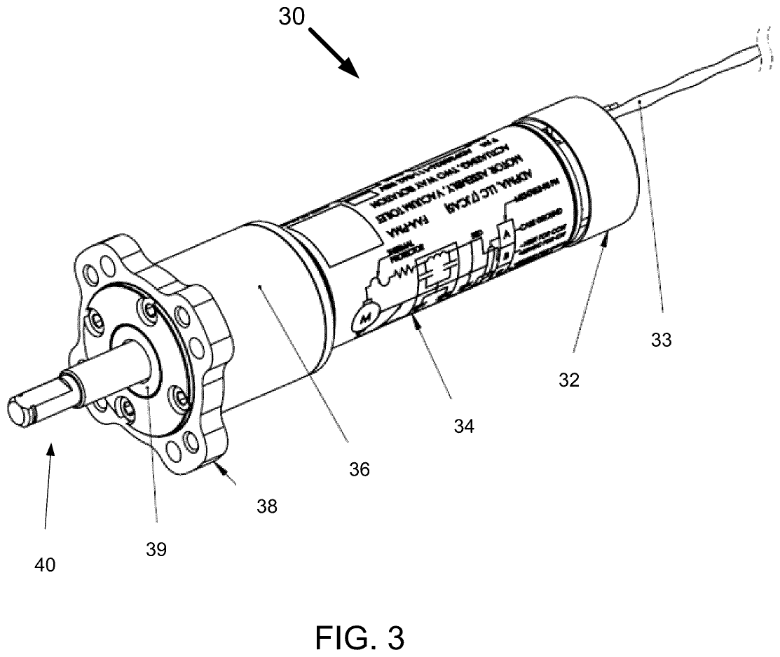

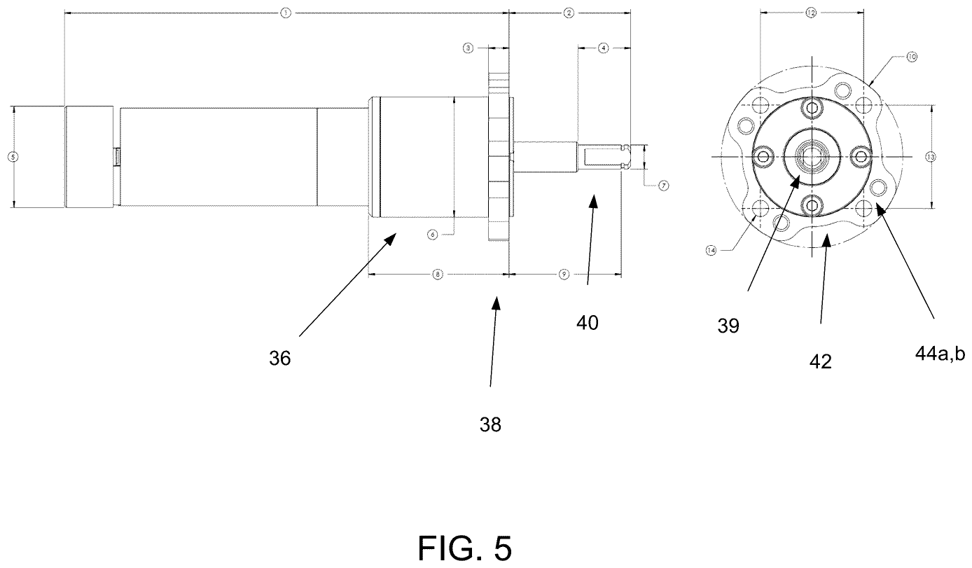

Improvements also have been made to the motor assembly, which is part of the vacuum toilet assembly and is controlled by the flush control unit to actuate the orbital flush valve (as described above). FIGS. 3-5 show the motor assembly 30 of the present invention, generally comprising an end bell 32 (configured to receive a cable assembly 33) a DC motor/housing 34, a gearbox 36, and a front flange 38 with a front shaft seal 39 and drive shaft 40. Internal components include a DC brushed motor with graphite brushes, a thermal protection/EMI filter printed circuit board (PCB), a three-stage planetary gearbox 36a, and preloaded stainless steel ball bearings 35.

Prior art motor assemblies mechanically attach the gearbox and the DC motor components together with screws. This construction can loosen with time, and allows penetration of water, dust, and other contaminants at the joint. In the present invention, the gearbox and the DC motor are laser-welded together. This prevents the penetration of water, dust and other contaminants, thereby greatly improving water and dust protection characteristics.

Further, prior art front flanges are square with four clearance holes, and are mounted by inserting mounting bolts from the outside through the clearance holes, and securing the bolts on the inside with locknuts. The front flange 38 of the present invention is a universal circular front flange with cutouts 42, with a set of four clearance holes 44a and a set of four threaded holes 44b. The cutouts reduce the flange weight. The set of four clearance holes may be used with mounting bolts as described above, while the threaded holds may used for mounting in applications where a mounting fastener with threads is used.

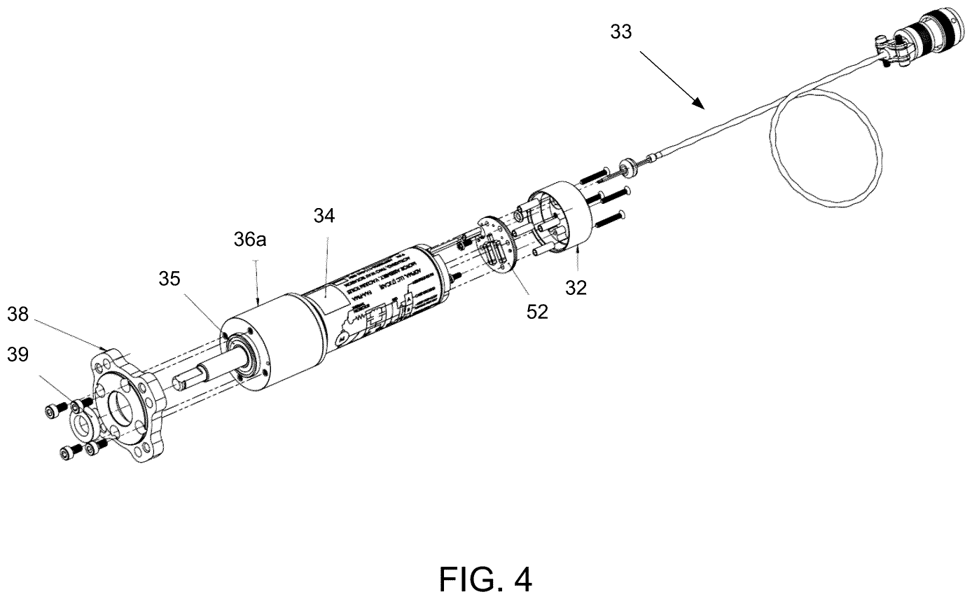

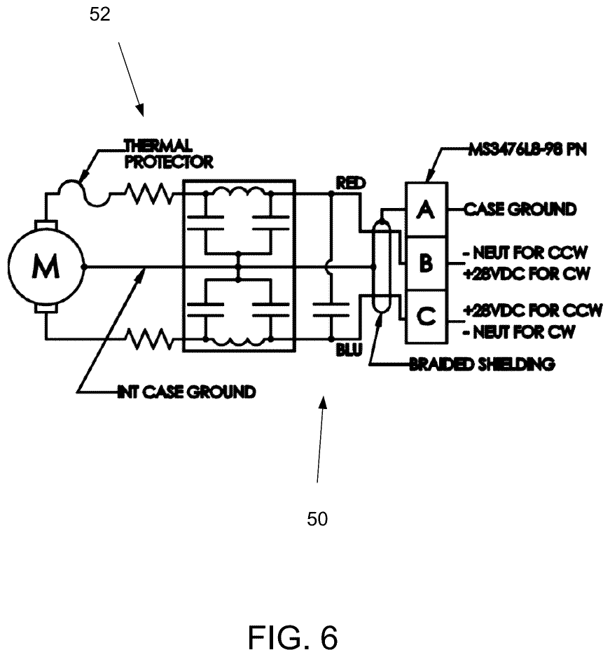

The present invention also has an improved end bell 32. The end bell in prior art assemblies is a flat plate attached with screws to the motor case or housing. The end bell of the present invention is not flat, but has a cavity construction to accommodate an electromagnetic interference (EMI)/thermal protection printed circuit board (PCB) 52 (see FIGS. 4 and 6). The end bell is sealed with a silicone compound during assembly to protect against water intrusion or other forms of contamination.

In addition, the present invention further comprises a front shaft seal 39 to provide protection from water and other contaminants migrating from the inside of the flush valve into the motor assembly. A common failure for prior art units occurs when a drainpipe is obstructed and the flush valve becomes flooded, which then forces wastewater and contaminants into the motor/drive unit through the front bearings 35. The environmental sealing 39 at the front flange of the present invention thus is superior to prior art assemblies.

Further, the present invention includes a thermal (overtemperature) protection and EMI filtering circuit 50, as seen in FIG. 6. The thermal protection circuit 52 comprises a single shot thermal fuse that disconnects input power from the motor when the functioning open temperature level is reached. The EMI filter, which is not present in prior art assemblies, prevents the electrical noise generated during the normal operation of the DC motor from propagating through the rest of the aircraft's electrical systems.

Accordingly, the present invention improves the durability and functioning of the flush valve assembly, resulting in better sealing and thereby helping reduce leakage around the flush valve assembly and scale and waste buildup in the lavatory system. It also provides a longer-lasting and more durable flush valve motor assembly.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A flush valve system for an aircraft, comprising:
a flush valve assembly housing with a slide plate with a through-hole extending through a portion of the slide plate, wherein the slide plate is rotatably connected to the flush valve assembly housing from a closed position to an open position;
wherein in the closed position, a solid portion of the slide plate extends across a fluid channel to prevent fluid flow through the fluid channel; and
wherein in the open position, the portion of the slide plate with the through-hole extend across the fluid channel to allow fluid flow through the fluid channel;
a face seal assembly adjacent to the slide plate; and
a face seal assembly adjacent to the slide plate, said face seal assembly comprising at least one quad-seal in contact with the slide plate and a housing groove proximate the slide plate, wherein the at least one quad-seal comprises a four-lobed X-shape in cross section and has multiple points of contact with the slide plate and the housing groove.

2. The flush valve system of claim 1, further wherein the quad-seal has two points of contact with the slide plate.

3. The flush valve system of claim 2, further wherein the quad-seal has two points of contact with the side-wall of the housing groove and two points of contact with the inner wall of the housing groove.

4. The flush valve system of claim 1, wherein the quad-seal comprises a solid piece of rubber.

5. The flush valve system of claim 4, wherein the rubber comprises nitril butadine.

6. The flush valve system of claim 1, wherein the housing comprises polyetheretherketone polymer.

7. The flush valve system of claim 1, wherein the through-hole is without chamfers or sharp edges.

8. The flush valve system of claim 1, wherein the slide plate comprises 400 C stainless steel and is electropolished to a 4 micro-finish.

9. The flush valve system of claim 1, further comprising a motor assembly connected to the flush valve assembly housing, said motor assembly configured to rotate the slide plate.

10. The flush valve system of claim 9, said motor assembly comprising:
an end bell;
a DC motor and housing connected to the end bell;
a gearbox connected to the DC motor and housing;
a front flange connected to the gearbox;
a drive shaft extending from the DC motor and housing through the front flange; and
a front shaft seal configured to sealingly surround a portion of the drive shaft proximate the front flange.

11. The flush valve system of claim 10, where the gearbox and DC motor and housing are connected by laser-welding.

12. The flush valve system of claim 10, wherein the front flange is circular with cutouts, with a set of four clearance holes and a set of four threaded holes, wherein each one of said set of four clearance holes is located proximate to a corresponding one of said set of threaded holes.

13. The flush valve system of claim 10, wherein the end bell is shaped in the form of a cup, and comprises an electromagnetic interference (EMI)/thermal protection printed circuit board (PCB).

14. A flushing control system for a vacuum toilet, comprising:
a flush valve assembly a housing with a slide plate with a through-hole extending through a portion of the slide plate, wherein the slide plate is rotatably connected to the flush valve assembly housing from a closed position to an open position;
wherein in the closed position, a solid portion of the slide plate extends across a fluid channel to prevent fluid flow through the fluid channel; and
wherein in the open position, the portion of the slide plate with the through-hole extend across the fluid channel to allow fluid flow through the fluid channel;
a face seal assembly adjacent to the slide plate;
a face seal assembly adjacent to the slide plate, said face seal assembly comprising at least one quad-seal in contact with the slide plate and a housing groove proximate the slide plate, wherein the at least one quad-seal comprises a four-lobed X-shape in cross section and has multiple points of contact with the slide plate and the housing groove; and
a motor assembly connected to the flush valve assembly housing, said motor assembly configured to rotate the slide plate, said motor assembly comprising
an end bell;
a DC motor and housing connected to the end bell;
a gearbox connected to the DC motor and housing;
a front flange connected to the gearbox;
a drive shaft extending from the DC motor and housing through the front flange; and
a front shaft seal configured to sealingly surround a portion of the drive shaft proximate the front flange.

15. The flushing control system of claim 14, further wherein the quad-seal has two points of contact with the slide plate, two points of contact with the side-wall of the housing groove, and two points of contact with the inner wall of the housing groove.
